(19) United States
(12) Patent Application Publication
(10) Pub. No.: US 2026/0367860 A1
(43) Pub. Date: Nov. 19, 2026

(54) AUDIO CONTENT OUTPUT CONTROL FOR DEVICES

(71) Applicant: BOSE CORPORATION, Framingham, MA (US)

(72) Inventors: Thomas David CHAMBERS, Bellingham, MA (US); Cameron HUDSON, Waltham, MA (US)

(21) Appl. No.: 19/207,049

(22) Filed: May 13, 2025

(51) Int. Cl. G06F 3/16

(52) U.S. Cl. CPC G06F 3/162; G06F 3/165

(57) ABSTRACT

Techniques, including output devices and systems implementing the techniques, for audio content output control. One example output device generally includes a sensor and one or more processors. The one or more processors are generally configured to receive, using the sensor, an audio signal, and when the audio signal includes audio content and one or more conditions are met, take one or more actions related to the audio content, where the one or more conditions include that the audio content is being output using an account of the user with a content provider. In this manner, the output of the audio content among two or more devices in the vicinity of the user may be controlled.

### FIELD

Aspects of the disclosure generally relate to devices, and, more particularly to techniques and output devices for audio content output control.

### BACKGROUND

Output devices, such as personal portable devices and speakers, are often utilized to output content to enable people to enjoy various forms of entertainment (e.g., music, videos, movies, television shows, sport events, games, podcasts, or other similar entertainment). For example, a user may use an output device such as a smartphone to output audio and/or video content. In some cases, one or more other output devices, such as speakers, may be present in the vicinity of the user using the output device. The output device and the one or more other output devices may be different types of devices and may have differing capabilities for outputting audio. For example, an output device may include a greater number of acoustic drivers (or speakers) than another output device. In another example, one output device may include better quality acoustic drivers (or speakers) than another output device.

### SUMMARY

All examples and features mentioned herein can be combined in any technically possible manner.

Aspects of the present disclosure provide an output device of a user. The output device generally includes a sensor and one or more processors. The one or more processors are generally configured to receive, using the sensor, an audio signal, and when the audio signal includes audio content and one or more conditions are met, take one or more actions related to the audio content, where the one or more conditions include that the audio content is being output using an account of the user with a content provider.

In aspects, the output device includes a driver, where to take the one or more actions, the one or more processors are configured to automatically output the audio content using the driver without any interaction from the user.

In aspects, the one or more processors are configured to output the audio content using the driver by: terminating, using one or more first application programming interfaces of the content provider, output of the audio signal on another output device, where the audio content originates from the content provider, and begin outputting, using one or more second application programming interfaces of the content provider, the audio content using the driver.

In aspects, to take the one or more actions, the one or more processors are configured to: notify, using an indication, the user that the audio signal includes the audio content and that the audio content is being output using the account of the user.

In aspects, the indication includes a visual notification on the output device and where to notify, using the indication, the user, the one or more processors are configured to generate the visual notification.

In aspects, the indication includes an audible notification and where to notify, using the indication, the user, the one or more processors are configured to output the audible notification using a driver included in the output device.

In aspects, to take the one or more actions, the one or more processors are further configured to: in response to an input from the user that follows the indication, output the audio content using a driver included in the output device.

In aspects, the one or more conditions further include that the audio signal that includes the audio content is being output on another output device that is associated with the account of the user.

In aspects, the output device further includes a driver, where to take the one or more actions, the one or more processors are configured to automatically output the audio content using the driver and where the audio signal that includes the audio content continues to be received by the sensor after the audio content begins to be output using the driver.

In aspects, the one or more processors are further configured to determine that the audio signal includes the audio content when at least one of music, sound associated with video, or sound associated with an audio work is identified in the audio content.

In aspects, the one or more processors are further configured to determine that the audio content is being output using the account of the user by at least one of correlating the identified audio content with the account or authenticating the account with the content provider.

In aspects, the audio content includes sound associated with video being output on another output device and where to take the one or more actions, the one or more processors are configured to output the audio content using a driver included in the output device and output the video using a display.

In aspects, the one or more processors are further configured to, before taking the one or more actions related to the audio content, output an indication to the user that notifies the user that the audio signal includes the audio content and prompts the user to login to the account of the user with the content provider.

Aspects of the present disclosure are directed to a method. The method generally includes receiving, using a sensor included in an output device of a user, an audio signal, and when the audio signal includes audio content and one or more conditions are met, taking one or more actions related to the audio content, where the one or more conditions include that the audio content is being output using an account of the user with a content provider.

In aspects, taking the one or more actions includes outputting, using a driver included in the output device, the audio content.

In aspects, outputting the audio content includes: terminating, using one or more first application programming interfaces of the content provider, output of the audio signal on another output device, where the audio content originates from the content provider, and begin outputting, using one or more second application programming interfaces of the content provider, the audio content using a driver included in the output device.

In aspects, taking the one or more actions includes: notifying, using an indication, the user that the audio signal includes the audio content and that the audio content is being output using the account of the user.

Aspects of the present disclosure provide a non-transitory computer-readable medium including computer-executable instructions that, when executed by one or more processors of a wearable audio device, cause the wearable audio device to perform a method. The method generally includes: receiving, using a sensor included in the output device, an audio signal, and when the audio signal includes audio content and one or more conditions are met, taking one or more actions related to the audio content, where the one or more conditions include that the audio content is being output using an account of the user with a content provider.

In aspects, taking the one or more actions includes outputting, using a driver included in the output device, the audio content.

In aspects, outputting the audio content includes: terminating, using one or more first application programming interfaces of the content provider, output of the audio signal on another output device, where the audio content originates from the content provider, and begin outputting, using one or more second application programming interfaces of the content provider, the audio content using a driver included in the output device.

In aspects, taking the one or more actions includes: notifying, using an indication, the user that the audio signal includes the audio content and that the audio content is being output using the account of the user.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates another example system, in which aspects of the present disclosure may be implemented.

FIG. 3A illustrates an exemplary sound processing and playback device, in which aspects of the present disclosure may be implemented.

FIG. 3B illustrates an exemplary source device, in which aspects of the present disclosure may be implemented.

FIG. 4 illustrates example operations for audio content output control, in accordance with certain aspects of the present disclosure.

FIG. 5 is a block diagram of an example process flow for audio content output control during the operations of FIG. 3, in accordance with certain aspects of the present disclosure.

FIG. 6 is an example implementation of the example process flow of FIG. 5, in accordance with certain aspects of the present disclosure.

### DETAILED DESCRIPTION

Certain aspects of the present disclosure provide techniques, including output devices and systems implementing the techniques, for audio content output control. Such techniques may involve (i) receiving (e.g., capturing) an audio signal using a sensor (e.g., a sensor included in a first output device, such as a microphone), and (ii), when the audio signal includes audio content and one or more conditions are met, taking one or more actions related to the audio content. The audio signal may include the audio content when at least one of music, sound associated with video (e.g., movies, television shows, sport events, games, video clips, and the like), or sound associated with an audio work (e.g., an audio book, podcast, or the like). The audio signal may also include background noise from the environment of the first output device. The one or more conditions may include one or more of (i) that the audio content is being output using an account of a user of the first output device (e.g., an account of the user for a content provider) or (ii) that the audio signal that includes the audio content is being output on a second output device which is also associated with the account of the user. The one or more actions may include outputting the audio content using a driver (e.g., a driver included in the first output device) without any interaction from the user and/or notifying the user that the audio signal includes the audio content. In some cases, outputting the audio content using the driver may include terminating the output of the audio signal (which includes the audio content) on another output device (e.g., the second output device). In this manner, the output of the audio content among two or more devices in the vicinity of the user may be controlled (e.g., managed).

Output devices, such as personal devices and speakers, are often utilized to output content to enable people to enjoy various forms of entertainment (e.g., music, videos, movies, television shows, sport events, games, podcasts, or other similar entertainment). In some cases, a user may be using an output device such as a smartphone to listen to entertainment in a room that also includes one or more other output devices. The one or more other output devices may be any type of audio output devices, such as portable or built-in speakers. The output device and the one or more other output devices may be different types of devices and may have differing capabilities for outputting audio. For example, one of the output devices may include a greater number of acoustic drivers (or speakers) than the other output device(s). In another example, one output device may include better quality acoustic drivers (or speakers) than the other output device(s). However, the user may continue to use the original output device to listen to the entertainment, even when the one or more other output devices would produce improved sound (e.g., louder and/or higher quality sound). The user may continue to use the original output device instead of the one or more other more favorable output devices because of the effort associated with changing which output device is outputting the entertainment. For example, a user may be listening to music or watching a video using a smartphone in a room that includes one or more smart speakers. In this example, the user may continue to listen to the music or watching the video using the smartphone, instead of casting the music and/or the video to the smart speakers to enhance the listening experience. Accordingly, improved audio content output control for output devices is desired to enable users to easily utilize output devices that produce a better listening experience whenever the output devices are readily available without substantial effort.

Many output devices often include one or more sensors (e.g., microphones) to provide voice control capability for users. Aspects of the present disclosure may enable an output device to receive audio (using the one or more sensors included in an output device) and determine whether the audio includes audio content being output using an account of a user of the output device for a content provider to enable audio content output control for the output device and other nearby output devices. In this manner, audio content output control among multiple output devices may be managed to quickly and easily provide the best possible listening experience to the user with minimal (or at least reduced) effort from the user.

### An Example System

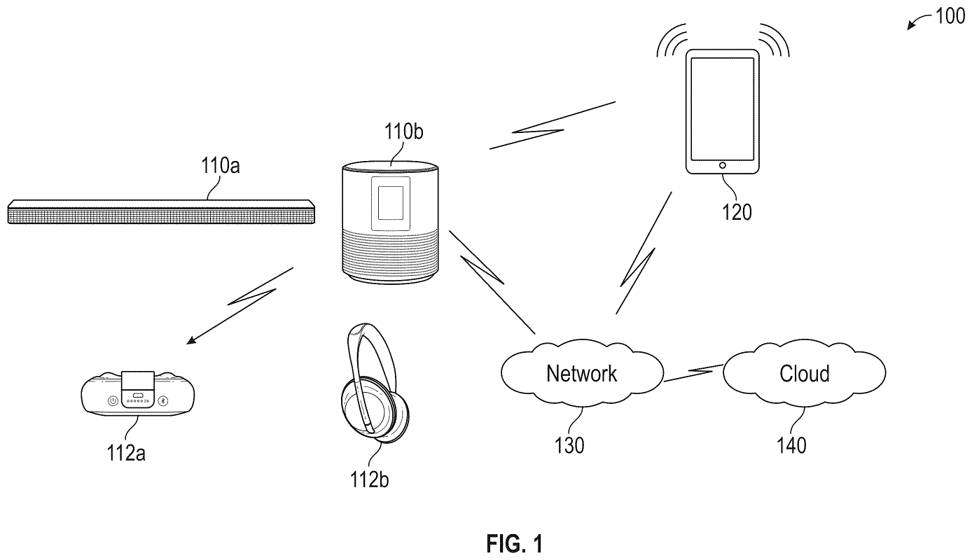

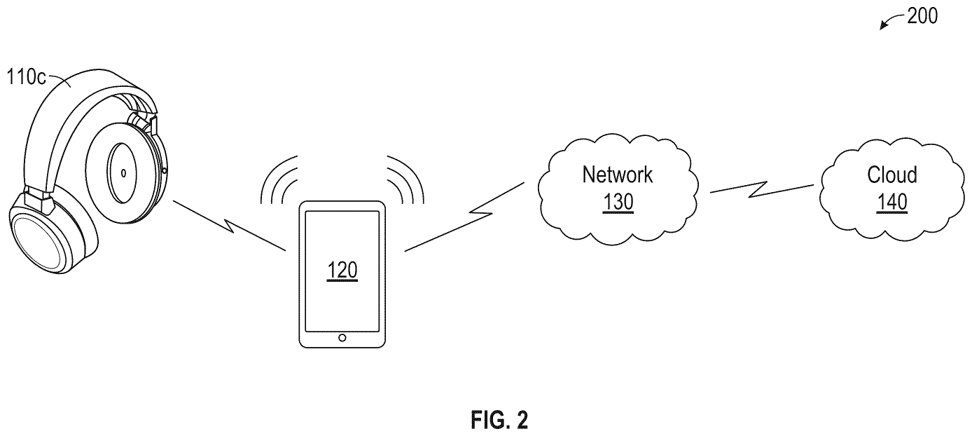

FIG. 1 illustrates an example system 100, in which aspects of the present disclosure may be implemented. As shown, system 100 includes one or more sound processing and playback devices 110 (e.g., a wireless audio device, such as a sound bar 110a, a speaker or smart speaker 110b, a wearable device 110c (shown in FIG. 2), and the like, collectively referred to herein as a sound processing and playback device 110) communicatively coupled with a source device 120 (e.g., a computing device or user device, such as a smartphone, tablet computer, personal computer, television, smart device, broadcast device, wearable device, and the like). Throughout the present disclosure, the sound processing and playback device 110 may be referred to simply as the device 110. In the example of FIG. 1, the device 110 is shown implemented as both a sound bar 110a and a speaker or smart speaker 110b. One or more partner devices 112 (e.g., a portable speaker 112a, a headset 112b, and the like, collectively referred to herein as partner device 112) may be available to accept pairing requests from the device 110 or the source device 120. The device 110 may be paired with the source device 120 and may receive content data (including audio signal(s)) from the source device 120. The device 110 may also receive content data directly from the network 130. The partner device 112 may be battery-powered portable devices suitable for mobile or privacy applications.

The device 110 may include hardware and circuitry including processor(s)/processing system and memory configured to implement one or more sound management capabilities or other capabilities including, but not limited to, noise cancelling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the device 110 by using active noise cancelling (also known as active noise reduction). The sound masking circuitry is configured to reduce distractions by playing masking sounds via the speakers of the device 110. The movement detecting circuitry is configured to use devices/sensors such as an accelerometer, gyroscope, magnetometer, and the like to detect whether the user wearing the device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In certain aspects, the device 110 may be wirelessly connected to the source device 120 or the partner devices 112 using one or more wireless communication methods including, but not limited to, Bluetooth, Wi-Fi, Bluetooth Low Energy (BLE), other radio frequency (RF) based techniques, and the like. In certain aspects, the device 110 includes a transceiver that transmits and receives data via one or more antennae in order to exchange audio data and other information with the source device 120.

In certain aspects, the device 110 includes communication circuitry capable of transmitting and receiving audio data and other information from the source device 120. The device 110 also includes an incoming audio buffer, such as a render buffer, that buffers at least a portion of an incoming audio signal (e.g., audio packets) in order to allow time for retransmissions of any missed or dropped data packets from the source device 120. For example, when the device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the device 110. This is done to ensure that even if there are RF collisions that cause audio packets to be lost during transmission, that there is time for the lost audio packets to be retransmitted by the source device 120 before they have to be rendered by the device 110 for output by one or more acoustic transducers of the device 110.

One example of the partner device 112 is shown as noise-canceling headphones; however, the techniques described herein apply to other wireless audio devices, such as wearable audio devices, including any audio output device that fits around, on, in, or near an ear (including open-ear audio devices worn on the head or shoulders of a user) or other body parts of a user, such as head or neck. The partner device 112 may take any form, wearable or otherwise, including standalone alone devices (including automobile speaker system), stationary devices (including portable devices, such as battery powered portable speakers), headphones, earphones, earpieces, headsets, goggles, headbands, earbuds, armbands, sport headphones, neckband, hearing aids, or eyeglasses with integrated speaker(s).

In certain aspects, the device 110 is connected to the source device 120 using a wired connection, with or without a corresponding wireless connection. The source device 120 can be a smartphone, tablet computer, personal computer, television, smart device, broadcast device, wearable device, a digital camera, or other user device that connects with the device 110. As shown, the source device 120 can be connected to a network 130 (e.g., the Internet) and can access one or more services over the network. As shown, these services can include one or more cloud 140 services.

In certain aspects, the source device 120 can access a cloud server in the cloud 140 over the network 130 using a mobile web browser or a local software application or “app” executed on the source device 120. In certain aspects, the software application or “app” is a local application that is installed and runs locally on the source device 120. In certain aspects, a cloud server accessible on the cloud 140 includes one or more cloud applications that are run on the cloud server. The cloud application can be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the device 110 in accordance with aspects of the present disclosure. In certain aspects, examples of the local software application and the cloud application include a gaming application, an audio AR application, and/or a gaming application with audio AR capabilities. The source device 120 may receive signals (e.g., data and controls) from the device 110 and send signals to the device 110.

FIG. 2 illustrates another example system 200, in which aspects of the present disclosure may be implemented. In the example of FIG. 2, the device 110 is shown implemented as a wearable device 110c configured to be worn by a user, and may be a headset that includes two or more speakers, as illustrated in FIG. 2. At a high level, the device 110 may play audio content transmitted from the source device 120. The user may use the graphical user interface (GUI) on the source device 120 to select the audio content and/or adjust settings of the device 110. The device 110 provides soundproofing, active noise cancellation, and/or other audio enhancement features to play the audio content transmitted from the source device 120.

The device 110 is illustrated in FIG. 2 as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, hearing aids, or eyeglasses.

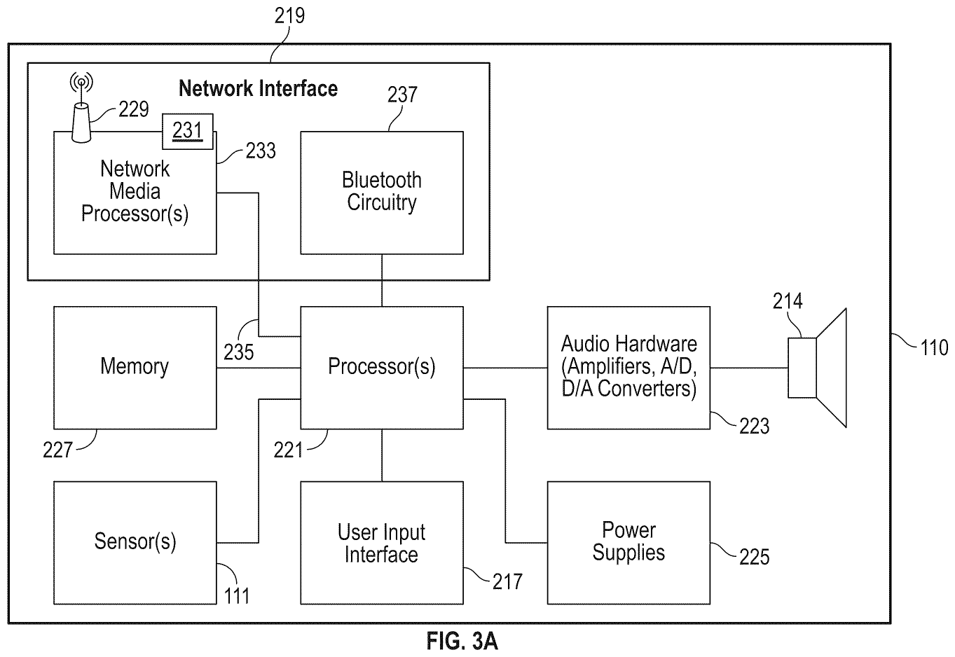

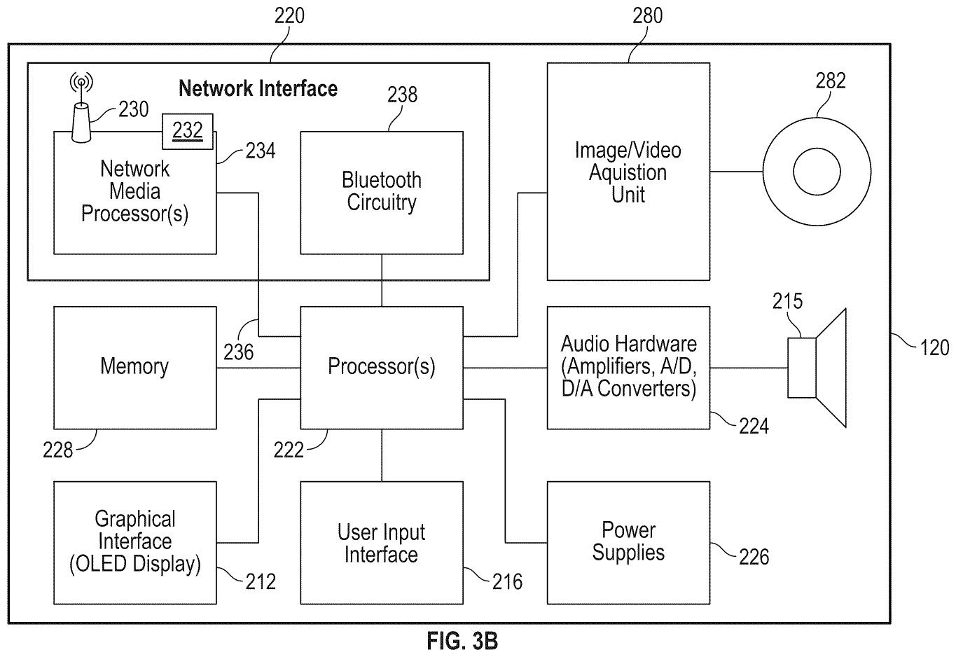

FIG. 3A illustrates an exemplary device 110 and some of its components. Other components may be inherent in the device 110 and not shown in FIG. 3A. For example, the device 110 may include an enclosure that houses an optional graphical interface (e.g., an organic light-emitting diode (OLED) display) which can provide the user with information regarding currently playing (“Now Playing”) music. In certain aspects, the partner device 112 may include components illustrated in FIG. 3A and described above.

The device 110 may include one or more electro-acoustic transducers (e.g., an acoustic driver or speaker) 214 for outputting audio. The device 110 may also include a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single device 110 may provide for single press access to various different digital audio sources.

The device 110 may include one or more sensors 111. The one or more sensors 111 may each include (or be implemented by) one or more microphones for capturing ambient sound and provide audio signals for determining location attributes of events. The transmission delays may be used to reduce errors in subsequent computation.

As shown in FIG. 3A, the device 110 may include one or more electro-acoustic transducers (e.g., an acoustic driver or speaker) 214 to transduce audio signals to acoustic energy through audio hardware 223. The the device 110 also may include a network interface 219, at least one processor 221, the audio hardware 223, power supplies 225 for powering the various components of the the device 110, and memory 227. In certain aspects, the processor(s) 221, the network interface 219, the audio hardware 223, the power supplies 225, and the memory 227 are interconnected using various buses 235, and several of the components can be mounted on a common motherboard or in other manners as appropriate. In some cases, the at least one processor(s) 221 may be included in a controller.

The network interface 219 provides for communication between the the device 110 and other electronic computing devices via one or more communications protocols, such as Bluetooth classic protocol, Bluetooth low energy protocol, and others. The network interface 219 provides either or both of a wireless network interface 229 and a wired interface 231. The wireless network interface 229 allows the the device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the the device 110 is not worn by a user. Although illustrated, the wired interface 231 is optional.

In certain aspects, the network interface 219 includes at least one network media processor 233 for supporting Apple AirPlay® and/or Apple Airplay® 2. For example, if a user connects an AirPlay® or Apple Airplay® 2 enabled device, such as an iPhone or iPad device, to the network, the user can then stream music to the network connected audio playback devices via Apple AirPlay® or Apple Airplay® 2. Notably, the audio playback device can support audio-streaming via AirPlay®, Apple Airplay® 2 and/or Digital Living Network Alliance's (DLNA) Universal Plug and Play (UPnP) protocols, all integrated within one device.

All other digital audio received as part of network packets may pass straight from the a least one network media processor 233 through a universal serial bus (USB) bridge (not shown) to t he processor(s) 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In certain aspects, the Bluetooth circuitry 237 may be the primary network interface 219 due to energy constraints. For example, the network interface 219 may use the Bluetooth circuitry 237 solely for mobile applications when the wearable device 210 adopts any wearable form. For example, BLE technologies may be used in the wearable device 210 to extend battery life, reduce package weight, and provide high quality performance without other backup or alternative network interfaces.

In certain aspects, the network interface 219 supports communication with other devices using multiple communication protocols simultaneously at one time. For instance, the the device 110 can support Wi-Fi/Bluetooth coexistence and can support simultaneous communication using both Wi-Fi and Bluetooth protocols at one time. For example, the the device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor(s) 221. The processor(s) 221 may execute instructions (e.g., for performing, among other things, digital signal processing, decoding, and equalization functions), including instructions stored in the memory 227. The processor(s) 221 may be implemented as a chipset of chips that includes separate and multiple analog and digital processors. The processor(s) 221 may provide, for example, for coordination of other components of the the device 110, such as control of user interfaces.

The memory 227 may store software/firmware related to protocols and versions thereof used by the device 110 for communicating with other networked devices, including the source device 120. For example, the software/firmware governs how the device 110 communicates with other devices for synchronized playback of audio. In certain aspects, the software/firmware includes lower level frame protocols related to control path management and audio path management. The protocols related to control path management generally include protocols used for exchanging messages between speakers. The protocols related to audio path management generally include protocols used for clock synchronization, audio distribution/frame synchronization, audio decoder/time alignment, and playback of an audio stream. In certain aspects, the memory can also store various codecs supported by the speaker package for audio playback of respective media formats. In certain aspects, the software/firmware stored in the memory can be accessible and executable by the processor(s) for synchronized playback of audio with other networked speaker packages.

In certain aspects, the protocols stored in the memory 227 may include BLE according to, for example, the Bluetooth Core Specification Version 5.2 (BT5.2 ). The the device 110 and the various components therein are provided herein to sufficiently comply with or perform aspects of the protocols and the associated specifications. For example, BT5.2 includes enhanced attribute protocol (EATT) that supports concurrent transactions. A new L2CAP mode is defined to support EATT. As such, the the device 110 may include hardware and software components sufficiently to support the specifications and modes of operations of BT5.2, even if not expressly illustrated or discussed in this disclosure. For example, the device 110 may utilize LE Isochronous Channels specified in Bt5.2.

The processor(s) 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random-access memory (NVRAM). In certain aspects, instructions (e.g., software) are stored in an information carrier. The instructions, when executed by one or more processing devices (e.g., the processor(s) 221), perform one or more processes, such as those described elsewhere herein. The instructions can also be stored by one or more storage devices, such as one or more computer or machine-readable mediums (for example, the memory 227, or memory on the processor(s)). The instructions can include instructions for performing decoding (i.e., the software modules include the audio codecs for decoding the digital audio streams), as well as digital signal processing and equalization. In certain aspects, the memory 227 and the processor(s) 221 may collaborate in data acquisition and real time processing with the one or more sensors 111.

FIG. 3B illustrates an exemplary source device 120, such as a smartphone or a mobile computing device, in accordance with certain aspects of the present disclosure. Some components of the source device 120 may be inherent and not shown in FIG. 3B. For example, the source device 120 may include an enclosure. The enclosure may house an optional graphical interface 212 (e.g., an OLED display), as shown. The graphical interface 212 provides the user with information regarding currently playing (“Now Playing”) music or video. The source device 120 includes one or more electro-acoustic transducers 215 for outputting audio. The source device 120 may also include a user input interface 216 that enables user input.

The source device 120 also includes a network interface 220, at least one processor 222, audio hardware 224, power supplies 226 for powering the various components of the source device 120, and memory 228. In certain aspects, the processor(s) 222, the graphical interface 212, the network interface 220, the audio hardware 224, the one or more power supplies 226, and the memory 228 are interconnected using the one or more buses 236, and several of the components can be mounted on a common motherboard or in other manners as appropriate. In certain aspects, the processor(s) 222 of the source device 120 is more powerful in terms of computation capacity than the processor(s) 221 of the the device 110. Such difference may be due to constraints of weight, power supplies, and other requirements. Similarly, the power supplies 226 of the source device 120 may be of a greater capacity and heavier than the power supplies 225 of the the device 110. In some cases, the at least one processor(s) 222 may be included in a controller.

The network interface 220 provides for communication between the source device 120 and the device 110, as well as other audio sources and other wireless speaker packages including one or more networked wireless speaker packages and other audio playback devices via one or more communications protocols. The network interface 220 can provide either or both of a wireless network interface 230 and a wired interface 232. The wireless network interface 230 allows the source device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include at least one network media processor 234 and Bluetooth circuitry 238, similar to the at least one network media processor 233 and Bluetooth circuitry 237 in the device 110 in FIG. 3A. Further, in aspects, the network interface 220 supports communication with other devices using multiple communication protocols simultaneously at one time, as described with respect to the network interface 219 in FIG. 3A.

All other digital audio received as part of network packets comes straight from the at least one network media processor 234 through one or more buses 236 (e.g., USB bridge) to the at least one processor 222 and runs into the decoders, DSP, and eventually is played back (rendered) via the electro-acoustic transducer(s) 215.

The source device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, full high definition (FHD) videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the device 110, may pass from the network interface 220 to the processor(s) 222. The processor(s) 222 executes instructions within the wireless speaker package (e.g., for performing, among other things, digital signal processing, decoding, and equalization functions), including instructions stored in the memory 228. The processor(s) 222 can be implemented as a chipset of chips that includes separate and multiple analog and digital processors. The processor(s) 222 can provide, for example, for coordination of other components of the audio source device 120, such as control of user interfaces and applications. The processor(s) 222 provides a processed digital audio signal to the audio hardware 224 similar to the respective operation by the processor(s) 221 described in FIG. 3A.

The memory 228 can include, for example, flash memory and/or NVRAM. In certain aspects, instructions (e.g., software) are stored in an information carrier. The instructions, when executed by one or more processing devices (e.g., the processor(s) 222), perform one or more processes, such as those described herein. The instructions can also be stored by one or more storage devices, such as one or more computer or machine-readable mediums (for example, the memory 228, or memory on the processor(s) 222). The instructions can include instructions for performing decoding (i.e., the software modules include the audio codecs for decoding the digital audio streams), as well as digital signal processing and equalization.

### Example Operations for Audio Content Output Control

Certain aspects of the present disclosure provide techniques, including output devices and systems implementing the techniques, for audio content output control. Such techniques may involve (i) receiving (e.g., capturing) an audio signal using a sensor (e.g., a sensor included in a second output device, such as a microphone), and (ii), when the audio signal includes audio content and one or more conditions are met, taking one or more actions related to the audio content. In this manner, audio content output control among multiple output devices may be managed to quickly and easily provide the best possible listening experience to the user with minimal (or at least reduced) effort from the user.

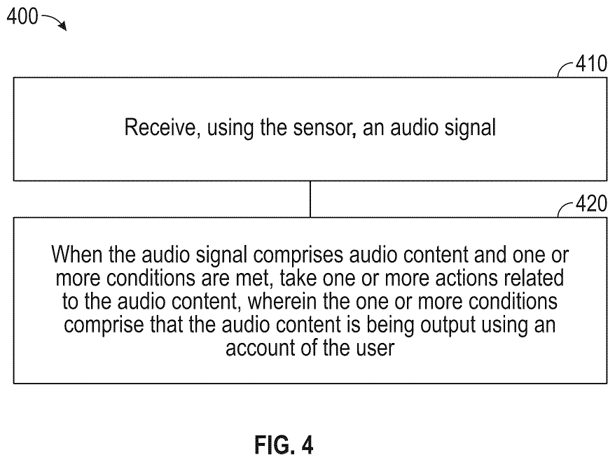

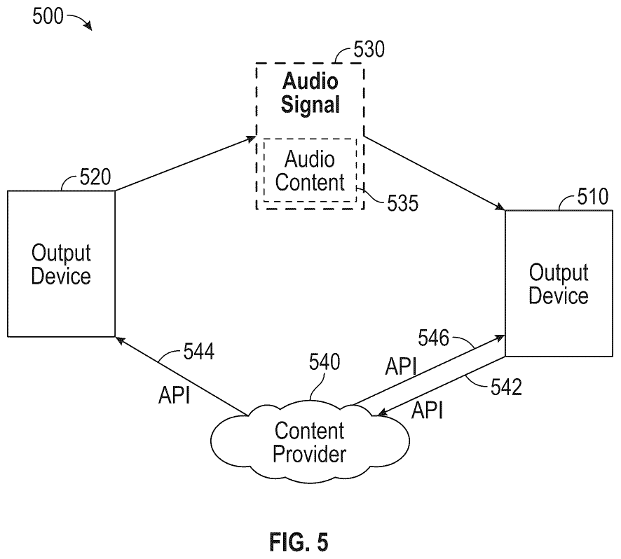

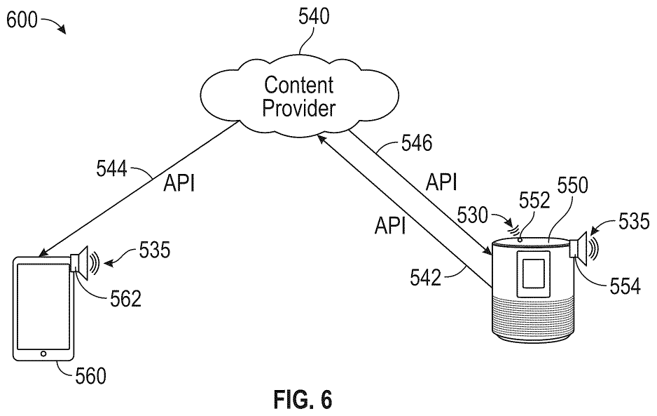

FIG. 4 illustrates example operations 400 for audio content output control, in accordance with certain aspects of the present disclosure. FIG. 5 is a block diagram of an example process flow 500 for audio content output control during the operations of FIG. 3, in accordance with certain aspects of the present disclosure. FIG. 6 is an example implementation of the example process flow 600 of FIG. 5, in accordance with certain aspects of the present disclosure. Therefore, FIGS. 4, 5, and 6 are herein described together for clarity. It is to be understood that anything described with respect to FIG. 5 is also applicable to the example implementation of FIG. 6.

The operations 400 may be performed by an output device 510 (e.g., the device 110 of FIG. 1, FIG. 2, and FIG. 3A, which may be implemented by, for example, a sound bar, a speaker, or a smart speaker, a wearable device, and the like, or an accessory device, such as the source device 120, which may be implemented as, for example, a smartphone, tablet computer, personal computer, television, smart device, broadcast device, wearable device, and the like) of a user (e.g., an owner of the output device 510, someone who previously used the output device 510, someone currently using the output device 510, and/or someone who may use the output device 510 in the future). For example, the operations 400 may be performed by the at least one processor(s) 221 included in the output device 510 implemented as a sound bar 110a or a speaker or smart speaker 110b (e.g., as illustrated in FIG. 1). When multiple processor(s) 221 are included in the device 110, the multiple processor(s) 221 may be configured to perform the operations 400 individually or collectively. The operations 400 and the process flow 500 may be utilized by the device 110 continuously, periodically, or selectively, as will be described herein.

The operations 400 may include, at block 410, receiving, at a sensor (e.g., sensor(s) 111 or another sensor included in the output device 510), an audio signal 530. The sensor may be implemented by one or more air conduction sensors (e.g., acoustic sensors). For example, the sensor may be implemented by one or more microphones. In certain aspects, the output device 510 may utilize microphone beamforming to more effectively capture the audio signal 530. In some cases, the audio signal 530 may include audio content 535, whereas in other cases, the audio signal 530 may not include any audio content 535. In all cases, background noise (e.g., ambient noise present in the environment surrounding the output device 510) may be present in the audio signal 530 and received at the sensor. The background noise may include, for example, one or more of speech from the user and/or others present in the vicinity of the user, sneezing, crying, laughing, alarms, sirens, sound associated with transportation, household noise, and/or other ambient sounds present in the environment surrounding the output device.

The audio signal 530 may be received from another output device 520 (e.g., the source device 120 of FIG. 1, FIG. 2, and FIG. 3B, which may be implemented by, for example, a computing device or user device, such as a smartphone, tablet computer, personal computer, television, smart device, broadcast device, wearable device, and the like). For example, the output device 520 may be implemented by a smartphone, and the user may be utilizing the smartphone to listen to audio content (e.g., music, videos, movies, television shows, sport events, games, podcasts, or other similar entertainment).

In some cases, the output device 510 may be a different type of device than the output device 520 and may be capable of providing superior sound (e.g., higher volume, better quality, a wider soundstage, and the like) compared to the output device 520. For example, the output device 510 may be implemented as speaker and the output device 520 may be implemented as smartphone. In this example, the speaker may have improved audio output capability (e.g., as a result of larger and/or higher quality audio output hardware) compared to the smartphone.

At block 420, the operations 400 may include, when the audio signal 530 includes the audio content 535 and one or more conditions are met, taking one or more actions related to the audio content 535. The one or more conditions may include that the audio content 535 is being output using an account of the user with a content provider 540. The content provider 540 may be a streaming service or other provider of content, and may include, for example, Spotify, Apple Music, Amazon Music, YouTube Music, Netflix, Hulu, Disney+, Max, Paramount Plus, Peacock, Twitch, YouTube, TikTok, and the like. For example, the content provider 540 may be Spotify, and the audio content 535 may be music or a podcast originating from Spotify. The account of the user may be a registered account of the user with the content provider 540 (e.g., an account with associated contact information and/or a password for signing in and/or an account that is recognized by the content provider 540). The account of the user with the content provider 540 may also, in some cases, be understood to instead be (or also include) a user accessing the content provider 540 without having and/or being logged into a formal registered account. For example, the account of the user with the content provider 540 could be or refer to, for example, an informal account (e.g., user access without a registered account) created by a user watching/listening to a video on YouTube without having a formal registered YouTube account (or without logging into and using the user's YouTube account).

In some cases, the one or more conditions may include that the audio content 535 is being output using the account of just the user, whereas in other cases, the account may be for the user and for one or more other users associated with the user (e.g., a shared account with the content provider 540). In yet other cases, the account may be an account of a family member or friend of the user. In certain aspects, the user may control which accounts with content providers 540 are stored on the output device 510 and/or the output device 520 and which accounts with content providers 540 are considered during the operations 400 (e.g., used when correlating the identified audio content 535 with the account of the user with the content provider 540 and/or authenticating the account of the user with the content provider 540, as described herein).

According to certain aspects, the operations 400 may further include determining that the audio signal 530 includes the audio content 535 when at least one of music, sound associated with video (e.g., movies, television shows, sport events, games, video clips, and the like), or sound associated with an audio work (e.g., an audio book, podcast, or the like) is identified (or recognized) in the audio content 535. In this manner, the operations 400 may ensure that the audio signal 530 includes actual audio content 535 and not just the background noise before any changes to the output of the output device 510 and/or the output of the output device 520 are made.

In certain aspects, determining that the audio signal 530 includes the audio content 535 may involve using one or more machine-learning models. In some cases, the machine-learning model may be a trained machine-learning model and may be implemented by a deep learning model. The trained machine-learning model may use various machine learning techniques based on artificial neural networks. For example, the trained machine-learning model, when implemented as a deep learning model, may include deep learning architectures, such as deep neural networks, deep belief networks, deep reinforcement learning, recurrent neural networks, convolutional neural networks, latent diffusion, transformers, and the like. In certain aspects, determining that the audio signal 530 includes the audio content 535 may involve using Shazam, or similar software, for audio content recognition and/or identification.

According to certain aspects, the operations 400 may further include determining that the audio content 535 is being output using the account of the user with the content provider 540 by at least one of correlating the identified audio content 535 with the account of the user with the content provider 540 or authenticating the account of the user and/or the audio content 535 itself with the content provider 540. In this manner, the operations 400 may cross-reference the audio content 535 with the user's account with the content provider 540 to ensure that the audio content 535 included in the audio signal 530 is currently being output for the user (e.g., listened to by the user) before proceeding to output the audio content 535 at the output device 510 and/or notifying the user that the audio signal 530 includes the audio content 535 (which are both described below).

The determining that the audio content 535 is being output using the account of the user may occur before, after, at the same time as the determining that the audio signal 530 includes the audio content 535. For example, it may be determined that the audio content 535 is being output using the account of the user first, and then it may be determined that the audio content 535 is being output using the account of the user with the content provider 540 (and in some cases, further determined that the audio content 535 is also being output on a device of the user, as described below). As a result, the operations 400 may help ensure that even if the audio signal 530 includes audio content, the audio content is actually being output by the user (e.g., using the account of the user), to prevent any changes to the output of the output device 510 and/or the output of the output device 520 when the audio signal 530 includes some audio content (e.g., from a source other than the output device 520), but the audio content is not actually being output using the user's account with the content provider and/or output on an output device of the user. In some cases, determining that the audio content 535 is being output using the account of the user may prevent the operations 400 from identifying audio content in the audio signal 530 that is not actually being output using the account of the user and/or on an output device of the user and changing the output of the audio content when the audio content is not relevant to the user (e.g., when the audio content is music, sound associated with video, or sound associated with an audio work from an output device of another person and/or output using another person's account with a content provider).

In some cases, determining that the audio signal 530 includes the audio content 535 and that the one or more conditions are met may involve using one or more application programming interfaces (APIs) 542 of the content provider 540. The output device 510 and/or the output device 520 may, in some cases, manage the one or more APIs of the content provider 540 to facilitate the operations described herein. In some cases, the output device 510 and/or the output device 520 may utilize one or more wireless connections with the content provider 540 to manage the one or more APIs and facilitate the operations described herein.

According to certain aspects, the one or more conditions at block 420 may further include that the output device 520 that is outputting the audio signal 530 that includes the audio content 535 is associated with the account of the user. The output device 520 may be associated with the account of the user when the account of the user is stored on the output device 520, when the user is an owner of the output device 520, and/or when the output device 520 is linked to the account of the user (e.g., linked to the account of the user with the content provider 540). In some cases, the operations 400 may help ensure that the audio signal 530 includes audio content 535, that the audio content 535 is being output using the account of the user, and that the audio content 535 is being output on a device of the user (e.g., output device 520), to further prevent audio content 535 output changes when the audio signal 530 includes the audio content 535, but the audio content 535 is not actually being output for the user (e.g., output using the account of the use and/or output on a device of the user) .

According to certain aspects, the output device 510 may include a driver (e.g., electro-acoustic transducer 214), and taking the one or more actions at block 420 may include automatically outputting the audio content 535 at the output device 510 using the driver without any interaction from the user (e.g., without a voice command from the user or a physical affordance of the user on the output device, such as pressing button). In this manner, after audio content 535 has been identified in the audio signal 530 and after it has been confirmed that the audio content 535 is being output using the account of the user, the operations 400 may facilitate automatically outputting the audio content 535 on the output device 510 without any user interaction and/or any notification to the user. As a result, the audio content 535 may be output on the output device 510 (e.g., to provide superior audio content 535 volume and/or quality) without any effort on the part of the user.

In some cases, automatically outputting the audio content 535 may include gradually or incrementally ramping up the output of the audio signal 530 at the output device 510 (e.g., gradually or incrementally increasing the volume of the audio content 535) over a period of time, whereas in other cases, outputting the audio content 535 may include abruptly outputting the audio signal 530 at the output device 510 at the desired final volume. The user may control (e.g., using one or more voice command and/or one or more physical affordances) whether the output of the audio content 535 (and/or the volume of the audio content 535) is gradual, incremental, or abrupt.

In certain aspects, automatically outputting the audio content 535 at the output device 510 may performed in accordance with settings on the output device 520. For example, one or more settings used to output the audio signal 530 from the output device 520 (e.g., the volume level, the applied equalization, any processing applied to the audio signal 530, and the like) may be replicated by the output device 510 when outputting the audio content 535. In this manner, the output device 510 may effectively replace (or augment) the output device 520 using the same settings without any user interaction. The user may control (e.g., using one or more voice command and/or one or more physical affordances) whether the settings of the output device 520 are wholly replicated and used by the output device 510 or whether the settings of the output device 520 are modified and used when the output device 510 outputs the audio content 535.

According to certain aspects, the operations 400 may include (i) terminating, using one or more APIs 544 of the content provider 540, output of the audio signal 530 on the output device 520, where the audio content 535 originates from the content provider 540, and (ii) begin outputting, using one or more APIs 546 of the content provider (e.g., to control the output device 510), the audio content 535 using the driver on the output device 510. In this manner, the output of the audio content 535 may essentially transition from being output on the output device 520 to being output on the output device 510. As a result, the user may benefit from improved output of the audio content 535 (e.g., louder and/or higher quality sound) using the output device 510.

In some cases, terminating the output of the audio signal 530 may include gradually or incrementally ramping down the output of the audio signal 530 (e.g., gradually or incrementally decreasing the volume of the audio content 535) on the output device 520 over a period of time, whereas in other cases, terminating the output of the audio signal 530 may include abruptly outputting the audio signal 530 at the output device 520 at the desired final volume. For example, the output of the audio signal 530 at the output device 520 may be gradually or incrementally ramped down while the output of the audio signal 530 at the output device 510 may be simultaneously gradually or incrementally ramped up.

According to certain aspects, the operations 400 may include notifying, using an indication, the user that the audio signal 530 includes the audio content 535 and that the audio content 535 is being output using the account of the user. In some cases, the notifying may accompany the automatic outputting of the audio content 535 on the output device 510.

According to certain aspects, taking the one or more actions at block 420 may include, in response to an input from the user (e.g., one or more voice commands and/or one or more physical affordances) that follows the indication, outputting the audio content 535 using the driver included in the output device 510. In this manner, the notifying may precede the automatic outputting of the audio content 535 on the output device 510, and the automatic outputting of the audio content 535 on the output device 510 may occur after the user indicates (e.g., using the input from the user) that the user wishes to transition the output of the audio content 535 from the output device 520 to the output device 510 or augment the output of the audio content 535 from the output device 520 by outputting the audio content 535 at the output device 510 too.

In some cases, the indication may include a visual notification (e.g., a light and/or a notification prompt) for the user on the output device 510 and/or the output device 520. In these cases, the output device 510 and/or the output device 520 may generate the visual notification on a display of the output device 510 (e.g., user input interface 217) and/or a display of the output device 520 (e.g., user input interface 216). In other cases, the indication may include an audible notification on the output device 510 and/or the output device 520. In these cases, the output device 510 and/or the output device 520 may output the audible notification (e.g., an audible prompt or request, such as a voice message) for the user using the driver included in the output device 510 and/or a driver included in the output device 520 (e.g., electro-acoustic transducer 215). In yet other cases, the indication may include both the visual notification on the output device 510 and/or the output device 520 and the audible notification on the output device 510 and/or the output device 520. It is to be understood that any combination of the visual notification and/or the audible notification may be output on one or both of the output device 510 and/or the output device 520. In one example, the visual indication may be a software application notification on the output device 520 informing the user that the output device 510 is available and may (if the user accepts) begin to output the audio content 535 (either in place of the output device 520 or in addition to the output device 520).

According to certain aspects, taking the one or more actions at block 420 may include automatically outputting the audio content 535 using the driver included in the output device 510 while the audio signal 530 continues to be received by the sensor (e.g., the output device 520 continues to output the audio content 535). In this manner, the output device 510 may output the audio content 535 to augment the output of the audio content 535 by the output device 520 (e.g., to provide a wider soundstage with more acoustical range). In certain aspects, the output device 510, the output device 520, or one or more other output devices may be controlled in any combination to output the audio content 535. In some cases, any output devices present in the vicinity of the user (e.g., in the same room or space as the user) may be used to output the audio content 535. For example, as the user moves from room to room, the output devices in the same room or vicinity as the user may be used to output the audio content 535, and any output devices not in the same room or vicinity as the user may refrain from outputting the audio content 535. In this manner, output devices (and their respective speakers) may be added and/or removed from the one or more output devices being used to output the audio content 535 as the user moves from one room or area to another room or area, to help further optimize the listening experience for the user without any user intervention.

According to certain aspects, the audio content 535 may include sound associated with video that is being output on the output device 520 or another output device, and taking the one or more actions at block 4520 may include outputting the audio content 535 using the driver included in the output device 510 and outputting the video using a display included in the output device 510, a display included in a device with a wired and/or wireless connection to the output device, and/or a display in another output device. The sound associated with the video may include one or more of voices, sound effects, music, and/or periods of silence associated with video. In certain aspects, determining that the audio signal 530 includes the audio content 535 may involve using one or more audio signatures that are a complex combination of the entire soundtrack of the audio content 535 with sound associated with video, including voices, sound effects, music, and/or periods of silence in the audio content 535.

In some cases, and as illustrated in FIG. 6, the output device 510 may be implemented as speaker 550 with a sensor 552 and a driver 554 and the output device 520 may be implemented as smartphone 560 with a driver 562. In these cases, and as an example, the smartphone 560 may output the audio content 535 using the driver 562, the speaker 550 may receive the audio signal (e.g., the audio content 535 and any added background noise from the environment of the speaker 550) using the sensor 552 (e.g., block 410), and when the output device 510 identifies the audio content 535 in the audio signal 530 and one or more conditions are met, one or more actions related to the audio content 535 may be taken (e.g., block 420), such as outputting the audio content 535 at the speaker 550 using the driver 554 and/or notifying the user.

In some cases, the output device 510 may receive, at the sensor, the audio signal 530, and when the audio signal 530 includes the audio content 535 and one or more conditions are met, the output device 510 may take one or more actions related to the audio content 535. In these cases, the one or more conditions may include that the audio content 535 is being output using an account of the user with the content provider 540, and the account of the user may be an informal account (e.g., user access without a registered account) created by the user accessing the content provider 540 without having and/or being logged into a formal registered account. In these cases, any of the operations described herein may be performed by the output device 510 for audio content output control.

According to certain aspects, the operations 400 may further include, before taking the one or more actions related to the audio content 535 at block 420, outputting an indication to the user that notifies the user that the audio signal includes the audio content 535 and prompts the user to login to the account of the user with the content provider 540. The indication may be similar to the indication described above, and may include a visual notification, an audible notification, or both, that may be output on the output device 510 and/or the output device 520. In some cases, the output device 510 may receive the audio signal 530 and identify the audio signal 530 as being or including the audio content 535. However, in these cases, the output device 510 may not be associated with or connected to the audio account of the user with the content provider 540 (e.g., as a result of the output device 510 being a new device not previously setup by the user, the account of the user with the content provider 540 on the output device 510 being logged out, or any other reason). As a result, and in these cases, the output device 510 may output an indication to the user that (i) notifies the user that the audio signal includes the audio content 535 (e.g., that the audio content 535 has been recognized or identified), (ii) the audio content 535 may be outplayed with a higher output quality at the output device 510, and/or (iii) prompts the user to login to the account of the user with the content provider 540 on the output device 510. In these cases, when the user logs into the account of the user with the content provider 540 on the output device 510, the output device 510 may continue with the operations 400 at block 420 and/or with any other operations described herein.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program. For example, the computer readable storage medium can contain, for example, computer-executable instructions that, when executed by one or more processors of a device, individually or collectively, cause the device to perform the operations described herein.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. An output device of a user comprising:
a sensor; and
one or more processors configured to:
receive, using the sensor, an audio signal; and
when the audio signal comprises audio content and one or more conditions are met, take one or more actions related to the audio content, wherein the one or more conditions comprise that the audio content is being output using an account of the user with a content provider.

2. The output device of claim 1, further comprising:
a driver, wherein to take the one or more actions, the one or more processors are configured to automatically output the audio content using the driver without any interaction from the user.

3. The output device of claim 2, wherein the one or more processors are configured to output the audio content using the driver by:
terminating, using one or more first application programming interfaces of the content provider, output of the audio signal on another output device, wherein the audio content originates from the content provider; and
begin outputting, using one or more second application programming interfaces of the content provider, the audio content using the driver.

4. The output device of claim 1, wherein to take the one or more actions, the one or more processors are configured to:
notify, using an indication, the user that the audio signal comprises the audio content and that the audio content is being output using the account of the user.

5. The output device of claim 4, wherein the indication comprises a visual notification on the output device and wherein to notify, using the indication, the user, the one or more processors are configured to generate the visual notification.

6. The output device of claim 4, wherein the indication comprises an audible notification and wherein to notify, using the indication, the user, the one or more processors are configured to output the audible notification using a driver included in the output device.

7. The output device of claim 4, wherein to take the one or more actions, the one or more processors are further configured to:
in response to an input from the user that follows the indication, output the audio content using a driver included in the output device.

8. The output device of claim 1, wherein the one or more conditions further comprise that the audio signal that comprises the audio content is being output on another output device that is associated with the account of the user.

9. The output device of claim 1, further comprising:
a driver, wherein to take the one or more actions, the one or more processors are configured to automatically output the audio content using the driver and wherein the audio signal that includes the audio content continues to be received by the sensor after the audio content begins to be output using the driver.

10. The output device of claim 1, wherein the one or more processors are further configured to determine that the audio signal comprises the audio content when at least one of music, sound associated with video, or sound associated with an audio work is identified in the audio content.

11. The output device of claim 10, wherein the one or more processors are further configured to determine that the audio content is being output using the account of the user by at least one of correlating the identified audio content with the account or authenticating the account with the content provider.

12. The output device of claim 1, wherein the audio content includes sound associated with video being output on another output device and wherein to take the one or more actions, the one or more processors are configured to output the audio content using a driver included in the output device and output the video using a display.

13. The output device of claim 1, wherein the one or more processors are further configured to:
before taking the one or more actions related to the audio content, output an indication to the user that notifies the user that the audio signal comprises the audio content and prompts the user to login to the account of the user with the content provider.

14. A method comprising:
receiving, using a sensor included in an output device of a user, an audio signal; and
when the audio signal comprises audio content and one or more conditions are met, taking one or more actions related to the audio content, wherein the one or more conditions comprise that the audio content is being output using an account of the user with a content provider.

15. The method of claim 14, wherein taking the one or more actions comprises outputting, using a driver included in the output device, the audio content.

16. The method of claim 14, wherein outputting the audio content comprises:
terminating, using one or more first application programming interfaces of the content provider, output of the audio signal on another output device, wherein the audio content originates from the content provider; and
begin outputting, using one or more second application programming interfaces of the content provider, the audio content using a driver included in the output device.

17. The method of claim 14, wherein taking the one or more actions comprises:
notifying, using an indication, the user that the audio signal comprises the audio content and that the audio content is being output using the account of the user.

18. A non-transitory computer-readable medium comprising computer-executable instructions that, when executed by one or more processors of an output device of a user, cause the output device to perform a method, the method comprising:
receiving, using a sensor included in the output device, an audio signal; and
when the audio signal comprises audio content and one or more conditions are met, taking one or more actions related to the audio content, wherein the one or more conditions comprise that the audio content is being output using an account of the user with a content provider.

19. The non-transitory computer-readable medium of claim 18, wherein taking the one or more actions comprises outputting, using a driver included in the output device, the audio content.

20. The non-transitory computer-readable medium of claim 18, wherein outputting the audio content comprises:
terminating, using one or more first application programming interfaces of the content provider, output of the audio signal on another output device, wherein the audio content originates from the content provider; and
begin outputting, using one or more second application programming interfaces of the content provider, the audio content using a driver included in the output device.
